(19) United States
(12) Patent Application Publication
(10) Pub. No.: US 2007/0076680 A1
(43) Pub. Date: Apr. 5, 2007

(54) Segmented data delivery over non-reliable link

(75) Inventors: Noam Amram, Gan-Haim (IL); Leonid Entin, Modiin (IL)

Correspondence Address: WOLF, BLOCK, SCHORR & SOLIS-COHEN LLP, 250 PARK AVENUE, NEW YORK, NY, 10177, US

(73) Assignee: BAMBOO MEDIACASTING LTD, KFAR-SABA (IL)

(21) Appl. No.: 10/548,510

(22) PCT Filed: Mar. 3, 2004
(86) PCT No.: PCT/IL04/00204

§ 371 Date: Oct. 24, 2006

(30) Foreign Application Priority Data
Apr. 3, 2003 (IL) 154739

(51) Int. Cl. H04J 3/24

(52) U.S. Cl. 370/349

(57) ABSTRACT

A method of transmitting data. The method includes receiving data to be transmitted to a receiver, determining information on the structure of the received data, segmenting the received data into segments, in a manner determined responsive to the determined structure information and transmitting the segments to the receiver.

### FIELD OF THE INVENTION

The present invention relates generally to communication networks and particularly to avoiding data loss in packet based networks.

### BACKGROUND OF THE INVENTION

In transmission of data packets over packet based networks, there is a possibility of packet loss, such that it may be assumed that a certain percentage of packets are lost on any packet based network. The percentage of lost packets is generally a function of the quality of the network. In some cases, such as transfer of a file, the loss of a small percentage of the transmitted data prevents the use of the entire file. In other cases, such as transmission of audio signals in accordance with specific formats, the loss of a small percentage of the transmitted data may go substantially unnoticed, or may cause only a small degradation in quality.

In many uses of packet based networks, an acknowledgment scheme is used, in which a receiver notifies a transmitter, which packets were received or were not received and therefore require retransmission. In some cases, however, use of an acknowledgment scheme is not desired. For example, in providing real time audio or video, allowing for sufficient time to request retransmission adds substantial delay to the transmission. In addition, acknowledgment schemes add substantial complexity to both the receiver and the transmitter. Acknowledgment schemes are especially problematic for multicast transmissions, where a single packet is transmitted to a plurality of receivers. The number of retransmission requests for a multicast packet stream on a packet based network may flood the network.

Instead of using an acknowledgment scheme, or in addition to an acknowledgment scheme, transmission of redundant data packets may be used to reduce the chances of losing data. For example, each packet may be transmitted twice. Such redundant transmission, however is relatively wasteful in bandwidth. In order to limit the amount of bandwidth used for the redundant transmission, a forward error correction (FEC) method may be used. The use of a FEC method allows a higher chance of being able to reconstruct the lost data, with a lower percentage of extra transmitted data. The use of a FEC method, however, requires large processing resources for decoding. FEC methods may be used in one or more transmission layers. For example, A FEC method may be used in the network layer and/or in the application layer.

In the enhanced data GSM evolution (EDGE) cellular system, different FEC codes are used for the headers of the transmitted packets and for the data of the packets. The FEC of the header is optionally stronger than the PEC of the data, so as to reduce the chances of loss of the header beyond the chances of loss of data. Thus, even when a packet is lost, the header may be salvaged, giving some information on the data of the lost packet.

### SUMMARY OF THE INVENTION

An aspect of some embodiments of the invention relates to segmenting, for transmission, a stream of data into packets in a manner which takes into account an identification of data portions which are important for reassembly of the data stream in one or more higher layers. Optionally, the loss of one or more of the important data portions may cause an upper layer in a receiver to drop one or more data portions that were received by the receiver. In some embodiments of the invention, the important data portions comprise headers and/or tails of higher layer packets.

In some embodiments of the invention, the segmentation is performed in a manner which minimizes the number of segments including important data portions (these segments are referred to herein as important segments). Optionally, important data portions, such as headers, are fitted into a single segment when possible. Alternatively or additionally, important data portions are included in a plurality of segments.

Optionally, important data portions are not positioned at the end of a data segment and/or at the beginning of a data segment. In some embodiments of the invention, the data is loaded into segments, which indicate the end of packets of a layer directly above the segmenting layer. Optionally, the segmentation is performed such that the upper layer packet does not end at the end of the segment, so that the beginning of the next upper layer packet is located in the same segment as the indication on the position of the beginning of the packet. Thus, the indication may be protected from loss, as described below, together with the important data, in a single segment.

Optionally, the identification of the important segments is performed by receiving information on the structure of the data from upper layer units. This involves interrelation between layers which, for simplicity, is generally avoided in prior art communication systems.

An aspect of some embodiments of the invention relates to a method of transmitting segmented data over a lossy network. Segments including data portions identified as being important for reassembly (these segments are referred to herein as important segments) are optionally transmitted in a manner which reduces their chance of being lost.

In some embodiments of the invention, important segments are transmitted on a channel with a lower error rate relative to the remaining data. For example, important segments may be transmitted on a channel using a first modulation method, while other segments are transmitted on a channel using a second modulation method with a higher error rate, for example BPSK In an exemplary embodiment of the invention, important segments are transmitted on a wire link, while other segments are optionally transmitted on a parallel wireless link. In another exemplary embodiment of the invention, a plurality of channels (for example wireless channels) are used for transmitting the data. Optionally, the quality of the channels is periodically determined and according to the determination a high quality channel is selected for important segments.

Alternatively or additionally, the important segments are transmitted with redundancy. Optionally, important segments are transmitted in a plurality of copies. The plurality of copies of the important segments are optionally substantially identical. Alternatively or additionally, one or more of the copies includes substantially only the important data of the segment.

Alternatively or additionally, important segments are transmitted with a forward error correction (FEC) scheme or with a stronger FEC than used for non-important segments.

In some embodiments of the invention, the redundancy transmission is performed by a transmitter without the receiver being aware of the redundant transmission. The transmission is optionally performed such that the receiver will discard the redundant data as junk if it is not required. Optionally, the communication between the transmitter and receiver is governed by a protocol (or an operation mode of the protocol) which does not support redundant transmission. The transmitter prepares the redundant transmissions in a manner which will allow them to be used by the receiver when necessary even though the receiver was not configured to receive redundant transmissions.

In some embodiments of the invention, the transmission of data in the layer in which the segmentation is performed is unreliable, i.e., there is no guarantee that all the transmitted data was actually received by the receiver. Optionally, the receiver does not transmit acknowledge messages at all. Alternatively, the receiver transmits some acknowledge messages, for example for use as feedback in channel adaptation. In some embodiments of the invention, the entire transmission of the data in all the layers is unreliable. Alternatively, one or more layers above the segmenting layer, are reliable.

An aspect of some embodiments of the invention relates to a method of generating a forward error correction (FEC) code for transmitted data, which method takes into account the lower layer segmentation of the data.

In some embodiments of the invention, the FEC code comprises an erasure FEC code which takes into account the segmentation of the packets and hence is aware of which portions of data will be lost together.

In some embodiments of the invention, the FEC is generated while taking into account an uneven segmentation for transmission, of the data. In some embodiments of the invention, the FEC is generated on a version of the data which includes padding bits in positions selected according to the segmentation of the data for transmission. Optionally, the padding bits are inserted in place of headers added to the data for the transmission, such that each FEC unit is transmitted in a separate transmission segment which may be lost, e.g., RLC segment. Optionally, some of the data units used in calculating the FEC are shorter than others (they are padded with filler bits), while the FEC algorithm operates on equal size data units. The receiving unit optionally is configured with the segmentation of the data, for using the FEC.

An aspect of some embodiments of the invention relates to transmitting information in a cellular network to one or more mobile stations. The information is represented by a plurality of different data sequences, optionally including redundancy, such that at least two of the cells of the network transmit different data sequences.

In some embodiments of the invention, the information is represented by a plurality of data units, such that the information can be reconstructed from any combination of received data units, including at least a specific number of non-correlated data units. Optionally, different cells of the network, particularly adjacent cells, transmit different combinations of units. Thus, a mobile station moving between cells, possibly loosing some of the data units due to the movement, has a higher chance to collect a sufficient number of different data units. The transmission of different data units reduces the chances of receiving the same data units in two different cells due to a timing difference (e.g., loss of synchronization) between the cells.

Alternatively or additionally, measures are taken to prevent loss of synchronization between cells. In some embodiments of the invention, the cells are required to use the same bandwidth allocation in transmitting same data. Alternatively or additionally, a cell having a lower bandwidth allocation for the transmitted data is required to discard packets in order to keep synchronization with the other cells. The discarded packets are optionally redundant packets from each block of packets, such that data is not necessarily lost, although the chances of decoding the data in case additional packets are lost, is reduced.

An aspect of some embodiments of the invention relates to a method transmitting control information between a mediator and a receiver, in-band, in a cellular network. The control information is transmitted in specific segments which include important data. Optionally, measures are taken to reduce the chances the important data will be lost and therefore the chances that the control information will be lost is reduced. Alternatively or additionally, if the important data is lost the control information is not required.

There is therefore provided in accordance with an exemplary embodiment of the invention, a method of transmitting data, comprising receiving data to be transmitted to a receiver, determining information on the structure of the received data, segmenting the received data into segments, in a manner determined responsive to the determined structure information; and transmitting the segments to the receiver.

Optionally, determining information on the structure of the received data comprises receiving the structure information from an upper communication layer providing the data. Optionally, determining information on the structure of the received data comprises determining the structure information from the received data. Optionally, determining the structure information from the received data comprises examining the received data for predetermined bit sequences. Optionally, determining information on the structure of the received data comprises identifying portions of the data which if not received by the receiver will have an adverse affect on utilizing at least one portion of the data received by the receiver.

Optionally, identifying portions of the data comprises identifying packet headers of protocol layers above the segmenting layer. Optionally, identifying packet headers comprises receiving data from an upper communication layer and/or scanning the data for sequences of headers. Optionally, segmenting the data into segments comprises segmenting in a manner which minimizes the number of segments including identified portions. Optionally, segmenting the data into segments comprises segmenting such that identified portions are included in a single transmitted segment. Optionally, the method includes padding with filler bits, one or more upper layer packets of the received data, if necessary, in order to ensure that identified portions are included in a minimal number of transmitted segments.

Optionally, segmenting the data into segments comprises not positioning identified portions in the beginning of segments. Optionally, identifying portions of the data comprises identifying border portions of protocol layers above the segmenting layer, including a tail of a previous packet and a header of a following packet. Optionally, segmenting the data into segments comprises segmenting such that border portions are included in a single segment and/or identified border portions appear at the beginning of segments. Optionally, segmenting the data into segments comprises segmenting such that at least some of the segments include at least one complete upper layer packet.

Optionally, segmenting the data into segments comprises segmenting such that at least some of the segments includes a single upper layer packet. Optionally, segmenting the data into segments comprises including at least one specific identified portion in more than one segment.

Optionally, transmitting the segments comprises transmitting at least some of the segments including identified portions in a manner which reduces the chances that their data will be lost, relative to at least some other segments. Optionally, transmitting the segments comprises transmitting segments including identified portions separated by at least a predetermined number of segments not including identified portions.

There is further provided in accordance with an exemplary embodiment of the invention, a method of transmitting data, comprising receiving data to be transmitted to a receiver, segmenting the received data into segments, identifying segments including received data which is important for reassembly, and transmitting segments identified as including important data, with a reduced loss rate, relative to at least some of the non-identified segments.

Optionally, identifying segments including received data which is important for reassembly comprises identifying portions of the data which if not received by the receiver will have an adverse affect on utilizing data in at least one segment received by the receiver. Optionally, identifying segments including received data which is important for reassembly comprises identifying headers of one or more upper layer protocols. Optionally, identifying segments including received data which is important for reassembly comprises identifying based on information from an upper layer communication layer providing the data. Optionally, identifying segments including received data which is important for reassembly comprises identifying based on an examination of the received data. Optionally, transmitting segments identified as including important data, with a reduced loss rate comprises transmitting segments including important data on a low error rate channel. Optionally, transmitting segments identified as including important data, with a reduced loss rate comprises transmitting for segments including important data, at least one additional segment including the important data of the segment. Optionally, transmitting the at least one additional segment comprises transmitting an additional segment including substantially the same data as the original segment. Optionally, transmitting the at least one additional segment comprises transmitting an additional segment including substantially only the important data of the original segment. Optionally, transmitting the at least one additional segment comprises transmitting at least two segments including the important data of the original segment, each of the at least two segments including a portion of the data of the original segment not included by the others of the at least two segments.

Optionally, transmitting the at least one additional segment comprises transmitting the at least one additional segment separated from the transmission of the original segment by at least a predetermined number of segments or at least a predetermined amount of time. Optionally, the receiver is not adapted to handle the transmitted at least one additional segment. Optionally, transmitting segments identified as including important data, with a reduced loss rate comprises transmitting segments including important data with a forward error correction code.

There is further provided in accordance with an exemplary embodiment of the invention, a method of transmitting a data block to one or more cellular stations, comprising generating a plurality of different data sequences representing the data block and transmitting each of the different data sequences in a different cell of a cellular network servicing the cellular stations.

Optionally, generating the plurality of different data sequences comprises encoding the data block into a plurality of different data sequences. Optionally, generating the plurality of different data sequences comprises generating data sequences including the data block together with one or more forward error correction FEC units. Optionally, generating the plurality of different data sequences comprises generating a master sequence, and generating the plurality of different data sequences by forming sub-groups of the master sequence. Optionally, generating the master sequence comprises generating a first number of data units, such that the data block can be reconstructed from any sub-group of the master sequence including at least a second number of data units. Optionally, each transmitted data sequence includes at least a third number of data units, greater than the second number. Optionally, transmitting each of the different data sequences in a different cell comprises transmitting responsive to instructions generated by a central unit at substantially the same time. Optionally, transmitting each of the different data sequences in a different cell comprises transmitting the different data sequences such that their transmission times at least partially overlap.

### BRIEF DESCRIPTION OF FIGURES

Particular non-limiting embodiments of the invention will be described with reference to the following description of embodiments in conjunction with the figures. Identical structures, elements or parts which appear in more than one figure are preferably labeled with a same or similar number in all the figures in which they appear, in which:

FIG. 1 is a schematic illustration of a cellular network, useful in explaining an exemplary embodiment of the present invention;

FIG. 2 is a schematic illustration of formation of a stream of RLC segments, as is known in the art;

FIG. 3 is a flowchart of acts performed in generating RLC segments from IP packets, in accordance with an exemplary embodiment of the present invention;

FIG. 4 is a schematic illustration of a reconstruction process of LLC packets from received RLC segments in an exemplary scenario, in accordance with an exemplary embodiment of the invention;

FIG. 5 is a schematic illustration of a reconstruction of LLC packets from received RLC segments, following an exemplary scenario, in accordance with an exemplary embodiment of the invention;

FIG. 6 is a schematic illustration of a sequence of RLC segments, in accordance with an exemplary embodiment of the invention;

FIG. 7 is a schematic illustration of a division of an original data stream into RLC segments, in accordance with an exemplary embodiment of the invention;

FIG. 8 is a flowchart of acts performed in preparing a FEC for transmitted data, in accordance with an exemplary embodiment of the invention; and

FIG. 9 is a schematic illustration of packets transmitted for a fragment of application layer data, in accordance with an exemplary embodiment of the invention.

### DETAILED DESCRIPTION OF EMBODIMENTS

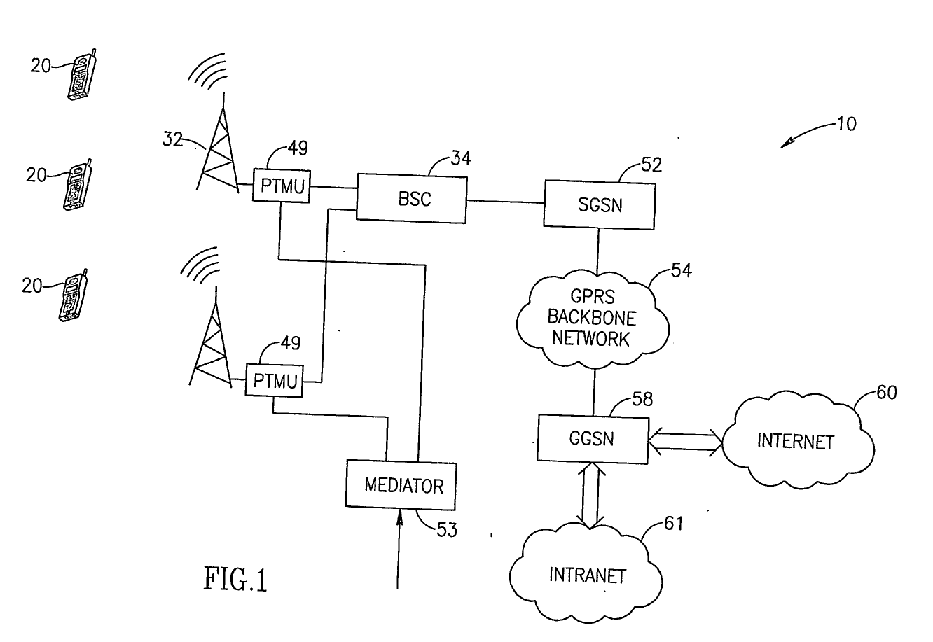

FIG. 1 is a schematic illustration of a cellular transmission network 10, useful in explaining an exemplary embodiment of the present invention. Cellular network 10 optionally includes a gateway GPRS support node (GGSN) 58, which serves as an interface between cellular network 10 and one or more external IP networks, such as the Internet 60, an Intranet 61 or any other data network. GGSN 58 exchanges packets, through a GPRS backbone network 54, with one or more serving GPRS support nodes (SGSNs) 52, which in turn communicates with mobile stations (MS) 20. Optionally, SGSN 52 communicates with MSs 20 through a base station controller BSC 34 and one or more base transmission stations (BTSs) 32, as is known in the art.

It is noted that the network of FIG. 1 is shown only as an example and that the present invention may be implemented in other cellular (GPRS, UMTS and other) and non cellular networks and systems. For example, the network in which the present invention is implemented may have additional elements, optionally for implementing multicast transmission, such as described in PCT Application No. PCT/IL02/00701, filed on Aug. 22, 2002, the disclosure of which is incorporated herein by reference.

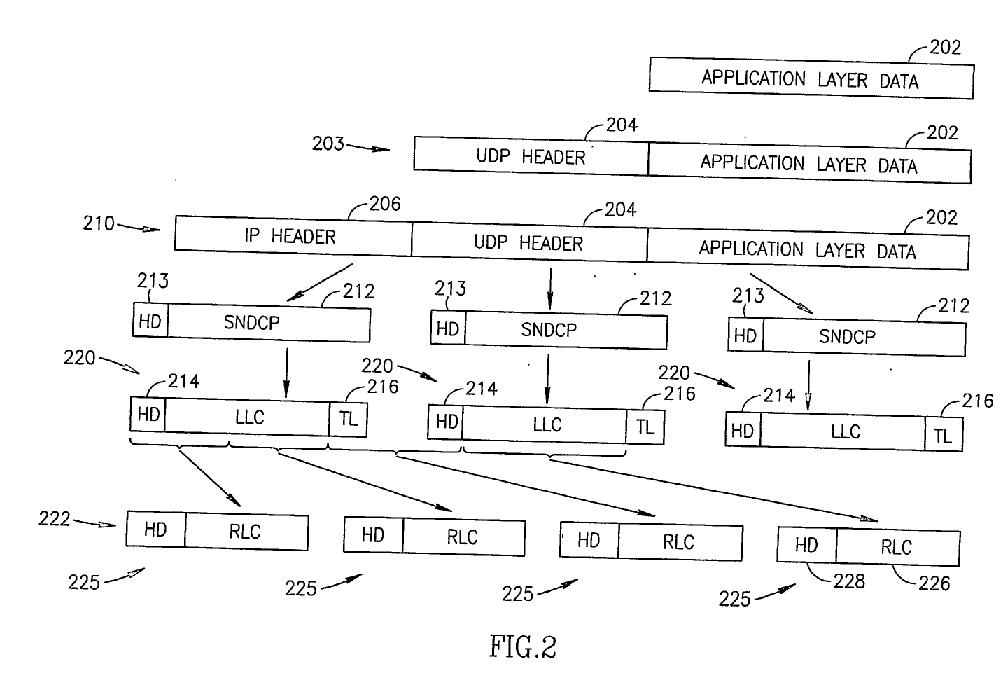

Data transmitted from Internet 60 to an MS 20 is optionally transmitted to GGSN 58, from the Internet, in IP packets. GGSN 58 transfers the IP packets to SGSN 52 which optionally parses the IP packets into logical link control (LLC) packets, as described below with reference to FIG. 2. The LLC packets are then transferred to BSC 34 which segments the LLC packets into radio link control (RLC) segments, which are then transmitted to their destination MS 20.

In some embodiments of the invention, the receiving MS 20 does not acknowledge the receipt of the RLC segments and does not request retransmission of RLC segments not received. This type of non-acknowledgment operation mode may be advantageous, for example, when -real time data is transmitted to an MS 20 and/or when multicast data is transmitted to a plurality of MSs 20. Alternatively or additionally, a non-acknowledgment operation mode may be used when an application layer handles retransmission and/or uses a FEC method.

Alternatively to transferring the data through GGSN 58, SGSN 52 and/or BSC 34, and optionally changing one or more thereof to implement the present invention, a bypass unit (referred to herein as a point to multi-point unit (PTMU) 49 located between BSC 34 and BTSs 32 emulates the operation of GGSN 58, SGSN 52 and/or BSC 34 to provide data in accordance with the present invention. Optionally, a mediator 53 receives data from a content provider, directly or through the Internet. The mediator optionally partially prepares the data for transmission and provides the data to PTMUs 49 of the cells in which the data is to be transmitted. The PTMUs 49 optionally complete the processing and provide the resultant RLC segments to BTSs 32 for transmission to MSs 20. An exemplary division of the tasks between mediator 53 and PTMUs 49 is described hereinbelow.

FIG. 2 is a schematic illustration of formation of a stream 222 of RLC segments, as is known in the art. Application layer data 202, generated by an application layer, such as HTTP or an audio source, is optionally encapsulated into a UDP datagram 203, which includes, in addition to data 202, a UDP header 204. The UDP datagram 203 is formed into an IP packet 210 by adding an IP header 206 to the UDP datagram. The IP packet 210 is transmitted from a data source, e.g., a source connected to Internet 60, to SGSN 52. SGSN 52 optionally parses the IP packet 210 into one or more SNDCP (Sub-Network Dependent Convergence Protocol) packets 212, each including an SNDCP header 213. Each SNDCP packet 212 is converted into an LLC packet 220 by adding an LLC header 214 and an LLC tail 216. In each LLC packet 220, the LLC tail 216 generally includes an error checking code (e.g., CRC) of the first seven bytes of the packet, which seven bytes include the LLC header 214 of the LLC packet and the SNDCP header 213 of the packet. For two adjacent LLC packets 220, the LLC tail 216 of the first packet and the first seven bytes of the second packet are referred to together as an LLC border portion between LLC packets. In some embodiments of the invention, as described below, the LLC border portion is always included in a single RLC segment, optionally in the beginning of the RLC segment.

LLC packets 220 are transmitted to BSC 34 where they are optionally filled into RLC segments 225 of an RLC segment stream 222, transmitted to MS 20. Each RLC segment 225 is optionally formed of an RLC data portion 226 and an RLC header 228. Header 228 optionally includes a block sequence number (BSN) of, for example, 7 bits which indicates the position of the RLC segment 225 within the stream 222. In addition, header 228 indicates the position at which an LLC packet 220 ends within the RLC segment 225, if such an LLC end exists in the RLC segment.

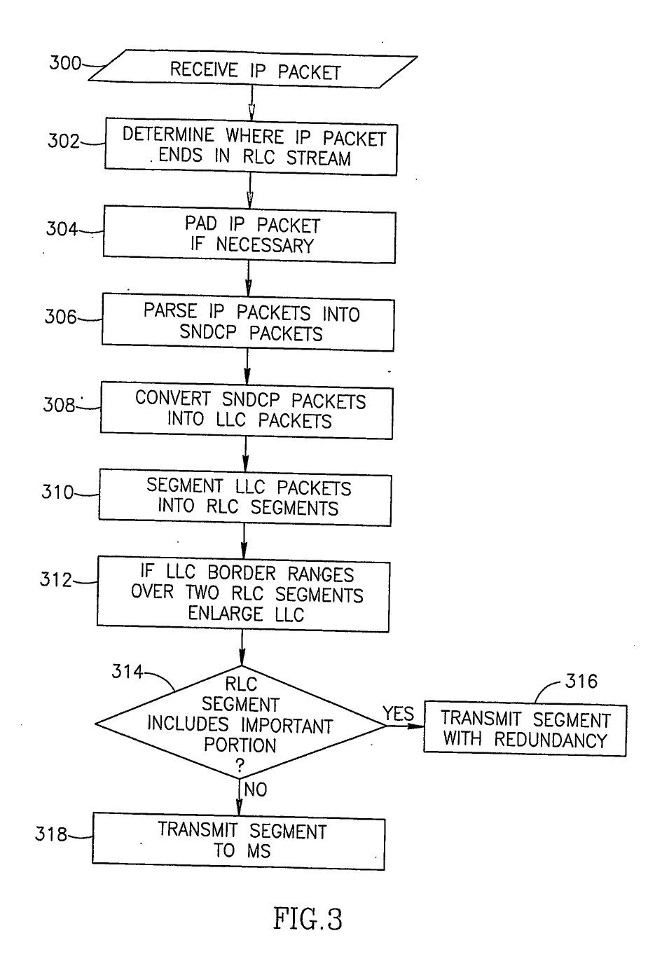

FIG. 3 is a flowchart of acts performed by PTMU 49 in generating RLC segments from IP packets, in accordance with an exemplary embodiment of the present invention. The method of FIG. 3 may be viewed as an improvement of the known process described with reference to FIG. 2. For each received (300) IP packet 210, PTMU 49 optionally determines (302) where the IP packet will end in the RLC segment stream 222, and hence where the next IP packet 210 will begin in the RLC stream 222. In some embodiments of the invention, if it is determined that the current IP packet 210 ends toward the end of an RLC segment, for example such that a header portion (including IP header 206 and UDP header 204) of a next IP packet will partially or entirely fit in a same RLC segment as the current IP packet, the current IP packet 210 is padded (304) with filler bits at its end.

Alternatively to the tasks of FIG. 3 being performed by PTMU 49, some or all of the tasks may be performed by other elements of the network, such as SGSN 52 and/or GGSN 58, which are changed accordingly, to perform the tasks of FIG. 3.

As is known in the art, the IP packets 210 are parsed (306) into SNDCP packets which in turn are converted (308) into LLC packets 220. In some embodiments of the invention, the parsing (306) of IP packets into SNDCP packets is performed in a manner which allows simple secure transmission of the IP header and/or the UDP header of the IP packet. Optionally, the parsing (306) is performed such that the IP and/or UDP header are included in one or more SNDCP packets separate from one or more other SNDCP packets which carry the data of the packet. Thus, it is easier to apply high quality transmission to header portions of the IP packets.

In some embodiments of the invention, the headers of the IP packet are parsed into SNDCP packets of a small size, such that each resultant LLC packet fits into a single RLC segment. The RLC header of the segment optionally identifies the beginning and the end of the LLC packet. In an exemplary embodiment of the invention, each RLC segment including IP header data includes an RLC header followed by an LLC header, an SNDCP header, IP header data and an LLC tail. Alternatively, all the IP header data of an IP packet is included in a single LLC packet.

The data of the IP packet is optionally parsed (306) into SNDCP packets of maximal size, in order to minimize the overhead involved in the SNDCP header and the LLC packet header and tail. Alternatively or additionally, when padding (304) of IP packets is required for proper fitting into the RLC segments, when possible, the padding is replaced by a breakup of one or more SNDCP packets into a plurality of packets.

The LLC packets 220 are then segmented (310) into RLC segments 225, as is known in the art. As mentioned above, an RLC header 228 is generated for each RLC segment 225. The RLC header 228 identifies the end points of LLC packets included in the RLC segment. In some embodiments of the invention, if (312) an RLC segment ends with a portion of an LLC border portion, without including the entire border portion, the LLC packet is optionally enlarged in order to avoid the breaking of the LLC border portion between two RLC segments 225. The LLC packet is optionally enlarged by adding padding bits at the end of the packet. The padding bits are optionally of a predetermined form which may be easily identified and removed by the application layer of the receiver. Optionally, messages including inadvertently the padding bits are slightly altered so that they will not be interpreted as padding bits. Alternatively, the LLC packet is enlarged by transferring data bytes from a following LLC packet to the current LLC packet. Alternatively, as described below, the sizes of the LLC packets and the IP packets are predetermined, so that the LLC border portion is always included in a single RLC segment.

In some embodiments of the invention, LLC packets are enlarged such that LLC border portions always appear at the beginning of an RLC segment. Having the LLC border always appear at the beginning of an RLC segment may simplify the operation of the application layer in MS 20, for example may simplify the calculations required for a forward error correction (FEC) code of the data. The FEC calculation is optionally simplified by having only two possible application data layouts in RLC segments. In a first layout, the entire data portion of the RLC segment includes application data and in a second layout the entire RLC data except for a first few bytes used for the LLC border portion are used for application layer data. Alternatively to enlarging the LLC packet in order to avoid transmitting an LLC border in two RLC segments, redundant transmission is performed for both the RLC segments.

In some embodiments of the invention, each generated RLC segment 225 is optionally checked (314) to determine whether the packet includes an LLC border, an IP header, a UDP header and/or portions thereof. The headers are optionally considered important portions, which should be transmitted to the receiver with a lower chance of loss, as their loss may cause inability to reconstruct large amounts of received data beyond the lost data.

RLC segments determined to include an important portion are optionally transmitted with redundancy (316). In some embodiments of the invention, for RLC segments 225 determined to include an important portion, an additional redundant RLC segment, including a copy of the important portion, is optionally generated, so as to reduce the chances of loss of the important portion. The LLC borders generally include sufficient information to allow reconstruction of an IP packet, even if some of the data of the packet was lost. Thus, the affect of the loss of a non-important RLC segment does not go beyond the actually lost bits. It is noted that in many cases, the loss of an LLC border would cause the loss of the entire IP packet in which the data of the lost LLC border was included.

The generated RLC segments (original and additional) are optionally transmitted (318) to MS 20, which regenerates IP packets from the RLC segments it receives. In some embodiments of the invention, the original and additional copies of an RLC segment are transmitted one after the other in order to allow simple association of the copies. Alternatively, for example when the receiver has a reception window of a sufficient size, the copies of a same RLC segment are transmitted with sufficient separation, such that the chances of loss of all the copies in a single burst of noise is relatively small. The separation is optionally of at least a predetermined amount of time and/or a predetermined number of intervening transmitted RLC segments. Alternatively or additionally, different RLC segments including important portions are transmitted, when possible, separated by a few non-important RLC segments, such that in case of damage by a bursty noise, the number of lost segments including important portions is minimal.

As to determining (302) where the IP packet will end in the RLC segment stream 222, the determination is optionally performed based on the known sizes of the LLC and RLC segments to be generated. In some embodiments of the invention, as described below, a predetermined layout of LLC packets and RLC segments is used, and the application data is fit into predetermined spaces of the predetermined layout, that are assigned for application layer data.

Referring in more detail to padding (304) the IP packet with filler bits, the padding is optionally performed such that the beginning of each IP packet is aligned with the beginning of a new RLC segment 225, for reasons discussed below. Inserting the IP header from the beginning of an RLC segment, may reduce the number of RLC segments 225 required for the IP header and hence requiring additional transmission for redundancy. Thus, aligning the beginning of the IP packet with the beginning of an RLC segment reduces the bandwidth required for redundancy.

The padding is optionally performed by adding a required number of bits after the IP packet, without changing the length indication of the IP packet. Thus, when received by MS 20, it will discard the padding bits as not belonging to any IP packet.

Alternatively or additionally to padding the IP packet, the size of the LLC packets are changed dynamically according to the sizes of the transmitted IP packets, such that the IP headers are always placed in RLC segments in a desired manner. Further alternatively or additionally, IP headers 206 are allowed to be included in RLC segments with non header data of the same IP packet and/or of a different IP packet. Optionally, redundant transmission is performed for any RLC segment including even a part of an IP header.

Referring in more detail to identifying packets including headers (314, FIG. 3), in some embodiments of the invention, the identification is performed based on information received from upper communication layers. Alternatively or additionally, the data is scanned for sequences which generally resemble headers. It is noted that in some embodiments the consequences of identifying data not belonging to a header as belonging to a header are not serious, as this will only add to the amount of data transmitted for redundancy. Therefore, the identification of data requiring redundancy may be performed with a relatively low accuracy. In some embodiments of the invention, the accuracy of the header identification is selected based on a compromise between the available bandwidth and processing power. The accuracy is optionally increased with the processing power and decreased with bandwidth.

In some embodiments of the invention, the additional RLC segments are exact copies of the original RLC segments for which they were generated, including the same block sequence number (BSN). If one of the original and additional packets is lost on its way to MS 20, the deciphering of the packet will proceed without problems. If, however, both the packets are received consecutively, MS 20 will assume that the second packet to be received is a different packet from the first to be received, as is now described.

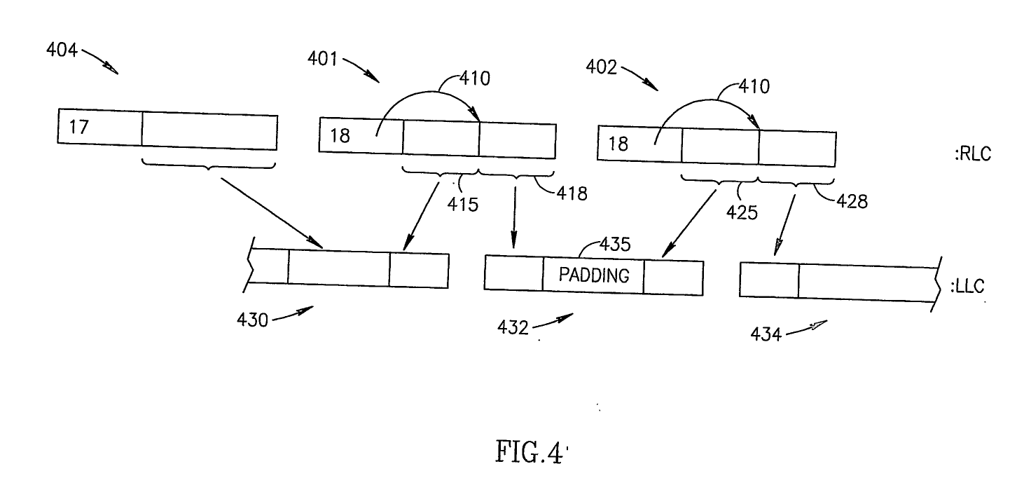

FIG. 4 is a schematic illustration of a reconstruction process of LLC packets from received RLC segments following an exemplary scenario, in accordance with an exemplary embodiment of the invention. In the example of FIG. 4, three received packets are shown, a first packet 404 with BSN=17, a second received packet 401, with BSN=18, and a third packet 402 identical to second packet 401, also having BSN=18. The second RLC segment 401 (and the third RLC segment 402, which is identical to the second packet) includes a pointer 410 to an ending point of an LLC packet within RLC segment 401. Thus, the data in RLC segment 401 is divided into two portions, a portion 415 belonging to a previous LLC packet and a portion 418 belonging to a following LLC packet. As RLC segment 402 is identical to packet 401 it is divided in the same manner to first and second portions 425 and 428.

During reconstruction, a first LLC packet 430 includes the data of RLC segment 404 and optionally data from previous RLC segments and the first portion 415 of RLC segment 401. The data included in LLC packet 430 ends at the end of portion 415, as indicated by pointer 410 of RLC segment 401. A following LLC packet 432 includes the second portion 418 of RLC segment 401 together with the first portion 425 of RLC segment 402. The data included in LLC packet 432 ends at the end of portion 425, as indicated by pointer 410 of RLC segment 402. Since MS 20 assumes that packets 401 and 402 are different, although they have the same BSN, MS 20 assumes that a series of RLC segments were lost. Therefore, MS 20 optionally adds to LLC packet 432, in a field 435, padding bits to replace the assumed missing RLC packets. The second portion 428 of RLC segment 402 is included in a further LLC packet 434, together with data from one or more subsequent RLC segments.

In checking LLC packet 432, a CRC check of the header of the packet will fail, as the tail including the CRC belongs to a different packet than the LLC header. Therefore, LLC packet 432 will be discarded. Thus, the data provided to an upper layer includes first portion 415 and second portion 428, covering exactly one copy of the transmitted data.

In some embodiments of the invention, the transmission times of the RLC segments are adjusted, in order to minimize the chances that the additional packet will be received by MS 20 after one or more subsequent packets are received. Optionally, the original packet and its duplicate are transmitted one after the other without delay and thereafter, a short, but substantial, delay is added before transmitting the subsequent RLC segment. Alternatively or additionally, the packets are transmitted on a communication channel which does not allow a different order of packets in reception than in transmission. For example, the RLC segments may be transmitted in time slots, and the time slots used for the RLC segments are ones which have fixed relative timings.

When both the original and additional copy of an RLC segment including a portion of an IP header are received by MS 20, each RLC segment will be converted into a separate LLC packet (as described above, the IP header is optionally broken up into separate LLC packets corresponding to respective RLC segments). The duplicate LLC packets will then optionally be identified by the LLC layer. In those embodiments in which the entire IP header is included in a single LLC packet, the duplicate RLC segments for all the RLC segments carrying data of the header are optionally transmitted after all the original RLC segments. If all the segments are received the duplication will be identified by the LLC layer. If one of the sets of RLC segments is received, even if one or more of the duplicates is lost, the IP header will be received by the LLC layer and the duplicates will be dropped.

Alternatively to the additional RLC segment having the same BSN as the original RLC segment it copies, the additional packet carries a consecutive BSN value to the value of the original copied RLC segment, as is now described.

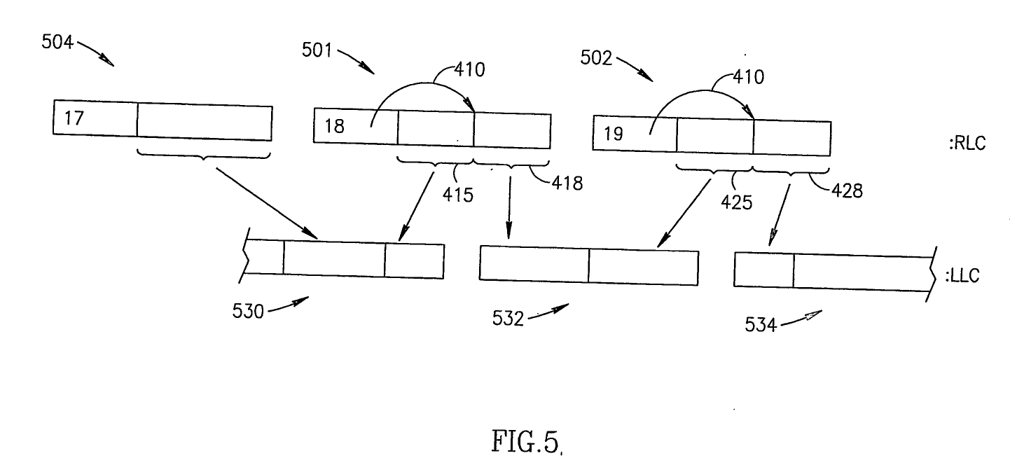

FIG. 5 is a schematic illustration of a reconstruction process of LLC packets from received RLC segments, following an exemplary scenario, in accordance with an exemplary embodiment of the invention. In the example of FIG. 5, three received RLC segments are shown, a first segment 504 with BSN=17, a second received segment 501, with BSN=18, and a third segment 502 substantially identical to second segment 501, except that it has a value of BSN=19. The second RLC segment 501 (and the third RLC segment 502, which is identical to the second packet) includes a pointer 410 to an ending point of an LLC packet within RLC segment 501. Thus, the data in RLC segment 501 is divided into two portions, a portion 415 belonging to a previous LLC packet and a portion 418 belonging to a following LLC packet. As RLC segment 502 is generally identical to RLC segment 501 it is divided in the same manner to first and second portions 425 and 428.

In reconstructing LLC packets, a first LLC packet 530 includes the data of RLC segment 504 (and optionally data from previous RLC segments) and the first portion 415 of RLC segment 501. The data included in LLC packet 530 ends at the end of portion 415, as indicated by pointer 410 of RLC segment 501. A following LLC packet 532 includes the second portion 418 of RLC segment 501 together with the first portion 425 of RLC segment 502. The data included in LLC packet 532 ends at the end of portion 425, as indicated by pointer 410 of RLC segment 502. Unlike the embodiment of FIG. 4, no padding bits are added to LLC packet 532. A third LLC packet 534 includes the second portion 428 of RLC segment 502, optionally together with data from one or more subsequent RLC segments.

In checking LLC packet 532, the CRC check fails as the tail does not match the header and therefore LLC packet 532 will be discarded. Thus, the data provided to an upper layer includes first portion 415 and second portion 428, covering exactly one copy of the transmitted data. Alternatively or additionally, proprietary measures are taken to make sure that the CRC check of packet 532 will fail.

If one of segments. 501 or 502 is lost, MS 20 will add padding bits instead of the “missing” RLC segment. The application layer optionally identifies the padding bits and removes them. In some embodiments of the invention, the application layer on MS 20 is aware of the segmentation structure and accordingly identifies the padding bits, as data is lost in entire RLC segments. The segmentation structure may be predetermined and/or may be transmitted to the receiver with each IP packet, group of IP packets and/or periodically, for example within the IP headers.

In some embodiments of the invention, the identification of the padding bits is performed by the application layer on MS 20 after the data is reconstructed into IP packets. In such cases, when padding bits are added, the end of the IP packet will be truncated according to the size of the IP packet indicated in the IP header. Optionally, in order to avoid loss of data, a predetermined number of bytes at the end of each IP packet including an important segment are padded with meaningless bytes. The number of meaningless bytes is optionally selected according to the number of important segments in the IP packet and/or the average loss rate on the transmission link to MS 20. Optionally, the meaningless padding bytes are not transmitted and instead the RLC numbers of the meaningless padding bytes are skipped. Thus, MS 20 will think that one or more RLC segments were lost and will replace them with padding bits. If additional padding bits were added in the middle of the IP packet, some or all of the padding bits at the end will be discarded due to the length of the IP packet. Otherwise, the padding bits at the end of the IP packet will be removed by the application layer.

Alternatively or additionally, an identification marker, for example having a length of 2-4 bytes, is added to each RLC segment. The application layer can then determine which RLC segments were lost according to the identification markers of the received RLC segments. This alternative is especially advantageous in those embodiments in which RLC segments of different lengths are used, and the receiver does not always know the number of bytes lost with an RLC segment.

As mentioned above with reference to FIG. 4, when both the original and additional copy of an RLC segment including a portion of an IP header are received by MS 20, each RLC segment will be converted into a separate LLC packet and the duplicate LLC packet will be dropped by the LLC layer. When only one of the original and additional copy of an RLC segment including a portion of an IP header is received, MS 20 will provide filler bits instead of the “missing” RLC segment. As these filler bits do not belong to an LLC packet they will be discarded.

Alternatively to always giving the same BSN to the copy segment as to the original segment or always giving a different BSN, at different time points and/or for different packets, different policies for assigning BSN numbers to copy segments, are used. For example, copies of RLC segments including IP header portions may be assigned a different BSN than the original segment, while copies of RLC segments including LLC border portions may be assigned a same BSN as the original segment.

Alternatively to the additional RLC segment (e.g., 402, 502) including all the bits of the original segment (e.g., 401, 501), the additional segment includes only some of the bits of the original segment (e.g., the important bits), and the remaining portion of the RLC segment is used for additional data, thus reducing the total number of transmitted RLC segments. In some embodiments of the invention, the additional RLC segment includes only the bits which caused the additional packet to be generated, for example, LLC header bits and/or IP header bits.

In some embodiments of the invention, in preparing the RLC segments for transmission, the sizes of the LLC packets are selected such that the border portions fit at the end of a first RLC segment and are repeated at the beginning of a subsequent RLC segment. Alternatively to repeating the entire border portion, only the LLC tail or only the LLC header are repeated. This alternative reduces the bandwidth required for redundancy but may cause additional loss of data, in case one of the RLC segments is lost.

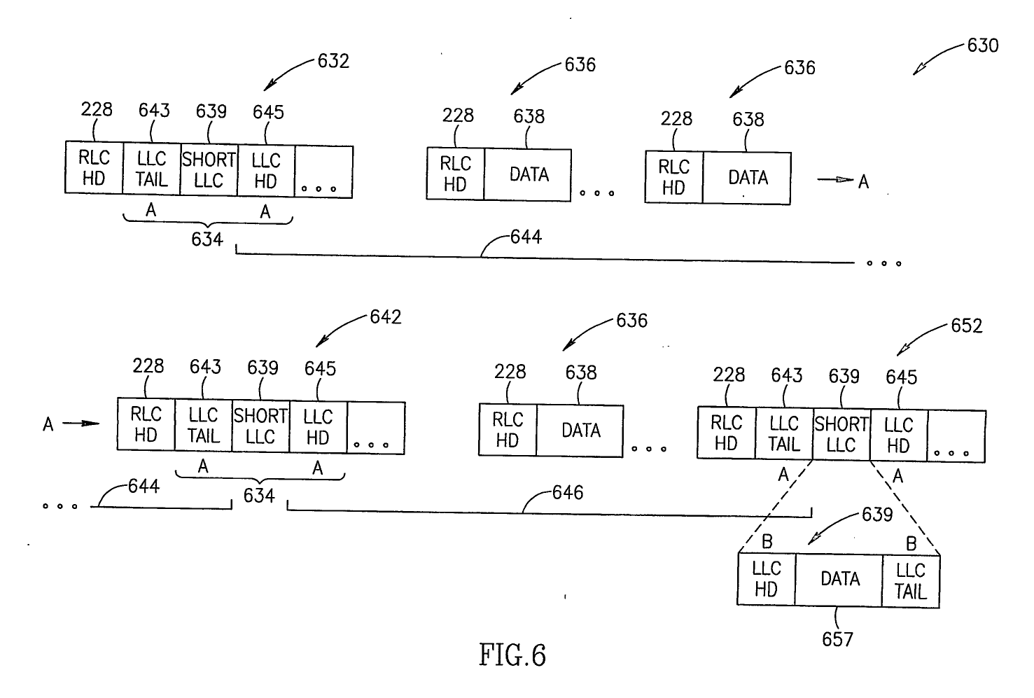

FIG. 6 is a schematic illustration of a sequence 630 of RLC segments, in accordance with an exemplary embodiment of the invention. As discussed above, sequence 630 includes important RLC segments 632, 642 and 652 including LLC border portions 634, and other RLC segments 636 including data 638. Each of RLC segments 632, 642, 652 and 636 optionally includes an RLC header 228, as is known in the art.

In order to reduce the damage in case an important RLC segment (the following description relates to segment 642 but is true for substantially any other important RLC segment) was lost (even though it was transmitted with redundancy), in some embodiments of the invention, all the regular LLC packets 644 and 646 have the same checksum value (referred to in FIG. 6 by the letter A). The LLC checksum values are optionally made the same by making the headers of the LLC packets identical. When all the checksum values are the same, if an important RLC segment 642 including an LLC border portion 634 is lost, the two LLC packets 644 and 646 referred to in the lost LLC border portion will be considered as one LLC packet by the receiver and most of the data will not be lost.

In some embodiments of the invention, in order to prevent the receiver from considering adjacent LLC packets 644 and 646 having the same checksum value as duplicate copies of a same LLC packet, each RLC segment including an LLC border portion 634 includes an additional short LLC packet 639 with a different checksum value (referred to in FIG. 6 by the letter B). Thus, the important RLC segments 632, 642 and 652 include an LLC tail 643 (in segment 642, of LLC packet 644) followed by an entire short LLC packet 639 having a different checksum and an LLC header 645 of an additional LLC packet (in segment 25 642, of LLC packet 646).

If RLC segment 642 is lost, the short LLC packet 639 is lost and the two LLC packets 644 and 646 of the border portion are considered as a single LLC packet. If the important RLC segment 642 is not lost, the short LLC packet 639 is received between the two LLC packets 644 and 646 of the border portion, such that the two LLC packets 644 and 646 of the border portion having the same checksum are not received one after the other and are not considered redundant.

In some embodiments of the invention, the short LLC packet 639 includes a minimal amount of data 657, e.g., one byte, required so that the short LLC packet is considered a valid packet. Alternatively, the short LLC packet includes a larger amount of data, for example filling the remaining portion of the RLC segment. Optionally, the short LLC packet includes data of the IP packet being transmitted. Alternatively, the short LLC packet includes meaningless filler bytes, removed by the application layer. Alternatively to the filler bytes being removed by the application layer, the short LLC packets 639 include an indication of a non-existent IP layer, which will cause the short LLC packets 639 to be discarded at the receiver.

It is noted that although LLC tail 643 is shown immediately after RLC header 228, this is not required, and data may be included in important RLC segments 632, 642 and/or 652, between RLC header 228 and border portion 634. Similarly, although important RLC segments 632, 642 and 652 are shown as including data after LLC header 645, this is not necessary, and the segments may end with LLC headers 645.

In some embodiments of the invention, additional packets for redundancy are transmitted for only some of the important packets, in order to reduce the bandwidth used for redundancy. Optionally, the headers for which additional copies are generated are selected randomly so as to provide an additional copy with a predetermined probability. Alternatively or additionally, the additional packets are generated for headers of relatively large packets and/or when the amount of data to be lost due to the loss of the header is relatively large.

Alternatively or additionally to transmitting redundant segments for important segments, in some embodiments of the invention, important segments are transmitted with a stronger coding scheme. For example, a mode in which RLC segments of different data lengths (the remaining portions of the RLC being used for redundancy coding) are used for redundancy transmission in accordance with the present invention. For example, regular data may be transmitted in RLC segments including 36 or 30 data bytes, while important segments are transmitted in RLC segments including 20 or 24 bytes of data. In this alternative, when data is lost, the application layer in the receiver optionally determines the amount of data lost according to the location of the lost RLC segment in the transmitted sequence, based on a predetermined arrangement of the transmissions.

It is noted that in the above description MS 20 is not adapted to handle redundant transmissions. Thus, the invention may be implemented without changing MSs 20. In some embodiments of the invention, however, MSs 20 are configured to identify redundant packets. In these embodiments, the operation of MSs 20 is simplified and they do not need to form LLC packets which are later discarded. Optionally, the transmission of packets is performed in a manner which is compatible with MSs 20 which are not adapted to handle redundant transmissions, and those MSs 20 which are adapted to identify the redundancy enjoy the advantages of simpler operation. In some embodiments of the invention, the MSs 20 identify the redundant packets by comparing the packets received to see that they are identical. Alternatively or additionally, any other method which does not include adding markings to the packets is used by MSs 20 to identify the redundant RLC segments. Further alternatively or additionally, markings are added to the redundant RLC segments, and/or to the packets for which copies were prepared, so as to allow easy identification by MSs 20 configured to identify the packets.

In some embodiments of the invention, the markings require that all the MSs 20 are configured to identify the redundant packets. These embodiments allow simpler methods of redundancy, but require configuration of all MSs 20 used.

Instead of generating redundant segments and/or in addition to the redundant segments, important RLC segments may be transmitted on a channel having a higher quality than the channel used for regular RLC segments. Optionally, the connection uses two channels for transmission of data. One of the channels has a higher bit rate and therefore a lower quality. Optionally, important segments are transmitted on the higher quality channel. Optionally, when there is additional bandwidth on the high quality channel, regular segments are transmitted on the high quality channel. Alternatively, regular segments are not transmitted on the high quality channel in order to further increase the quality level of the channel.

In some embodiments of the invention, as mentioned above, the application data transmitted to MS 20 is protected by a forward error correction (FEC) code, such that if some of the transmitted RLC segments are lost the data can still be reconstructed from those RLC segments which were received The FEC is optionally prepared with the data of each RLC segment serving is a separate unit of the FEC preparation. Since some RLC segments include an LLC border portion, these segments include less data. Optionally, in order to have equal size data units for FEC calculation, the data of which is to be packaged into a segment including an LLC border portion is padded with padding bits for the purpose of calculating the FEC. The padding bits are not transmitted to MSs 20.

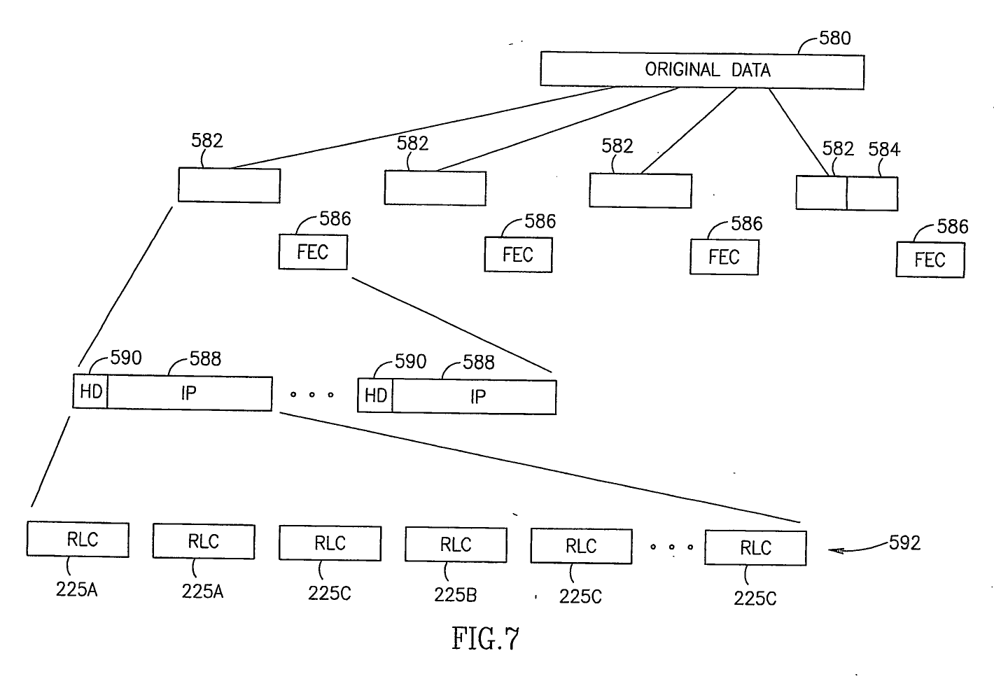

FIG. 7 is a schematic illustration of a division of an original data stream 580 into RLC segments 225, in accordance with an exemplary embodiment of the invention. Original data stream 580 is broken up into original data blocks 582, for each of which a respective PEC block 586 is generated. Each pair of original data block 582 and respective FEC block 586 is optionally broken up into a plurality of IP data packets 588, including a header 590 (e.g., including IP and UDP headers) together with a portion of block 582 and/or 586.

Each IP packet 588 is optionally loaded into a predetermined set 592 of RLC segments 225. In an exemplary embodiment of the invention, each set 592 includes a predetermined number of RLC segments 225 (marked 225A, 225B and 225C) which are pre-allocated to specific payloads. For example, two first RLC segments 225A carry header 590, while the remaining RLC segments 225 carry the blocks 582 and 586. Optionally, some of these RLC segments (marked 225B) include LLC border portions 634 (FIG. 6) and therefore carry fewer data bytes than the other RLC segments, which are marked 225C.

In some embodiments of the invention, each RLC segment carries a single data unit, which may either be a FEC data unit or an original-data unit. RLC segments 225B including LLC border portions 634 (FIG. 6) are optionally used only for original data units, as they include fewer data bytes than other RLC segments 225C. Each of the other segments 225C is designated to carry either FEC data or original data according to the total number of FEC units required relative to the number of original data units. The number of data bytes fitting into the RLC segments 225 assigned to carry original data associated with a block 582 is equal to the number of original data bytes in block 582. The number of data bytes fitting in the segments 225 assigned to carry FEC data associated with block 582 is equal to the number of bytes in FEC block 586.

In an exemplary embodiment of the invention, each data block 582 together with its respective FEC block 586 is fit into 15 IP packets, wherein each IP packet is fit into 17 RLC packets.

The use of a predetermined segmentation of the data and the loss of data only in predetermined patterns, allows the use of a simpler FEC, such as an erasure FEC. Such a FEC method does not require the determination of where the error occurred and therefore requires much less processing resources than if the finding of errors was required. In addition, such a FEC method requires lower redundancy rates of data transmission for achieving same chances of successful decoding of the data.

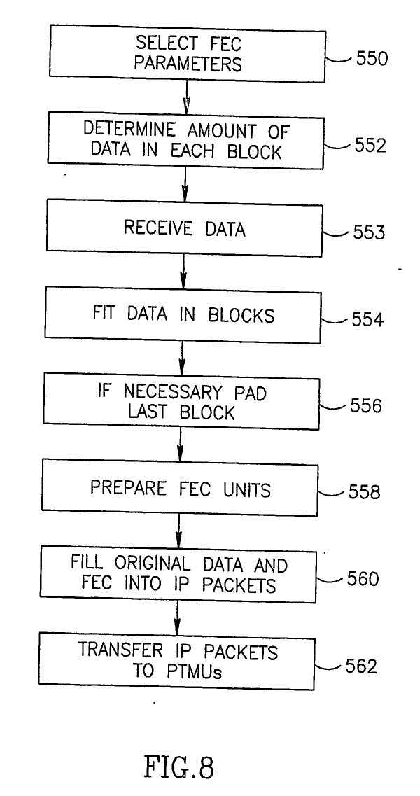

FIG. 8 is a flowchart of acts performed in preparing a FEC for transmitted data, in accordance with an exemplary embodiment of the invention. In preparing for generating a FEC, parameters of the FEC are selected (550). These parameters optionally include the amount of data included in each IP packet 588, the number of bytes in each FEC block 586 and/or the type of FEC used. The amount of original data included in each block 582 is determined (552) accordingly, based on the number of RLC segments 225B including LLC border portions 634 (FIG. 6) and the ratio between RLC segments including original data and RLC segments including FEC data. Optionally, the determined parameters and/or amount of original data in each block are predetermined values selected for a plurality of different transmissions. Alternatively, for each different transmitted data stream a different parameter selection is performed, for example according to the type of the data (e.g., real-time or non real-time) and/or the number and/or identity of the receivers.

When data is received (553) by mediator 53 for transmission, the original data 580 is fitted (554) into blocks of the predetermined size. In some embodiments of the invention, if necessary, the original data 580 is padded (556) with padding bytes 584 to include an integer number of original data blocks 582. Alternatively, the remaining data is handled in accordance with embodiments described above not involving predetermined segmentation. Further alternatively or additionally, predetermined segmentations are prepared for a plurality of block sizes and the block size used is selected according to the amount of data transmitted.

Thereafter, FEC units are prepared (558) for the data. The FEC is optionally prepared using any method known in the art. Optionally, in preparing the FEC units, original-data units shorter than others (e.g., corresponding to segments 225B including LLC border portions) are padded with padding bits (not shown in FIG. 7). The padding bits may include all ‘0’ bits, all ‘1’ bits and/or any other sequence of bits agreed between the transmitter and the receivers. Alternatively or additionally, a FEC method for units of uneven size is used.

Original data 580 and FEC units 586 are optionally filled (560) into IP packets 588 in an appropriate order, such that each data unit will fit into its pre-planned RLC segment 225. In some embodiments of the invention, the filled IP packets 588 are transferred (562) to PTMUs 49 of the cells in which they are to be transmitted. Each PTMU 49 optionally prepares the IP packets for transmission, as described above with reference to FIG. 3.

In some embodiments of the invention, the data is filled (560) into IP packets 588 according to the order in which they are generated, such that they will be transmitted in the order they were generated. Alternatively, the data of different blocks 582 is interleaved, so that in case a burst of consecutively transmitted segments are lost, not all the lost segments are from a single block. MSs 20 are optionally configured with the exact division used, for example as shown in FIG. 7, such that MS 20 has the exact positions of the FEC units the application layer of the MS 20 received from the LLC layer.

In some embodiments of the invention, one or more of the determined parameters of the FEC are transmitted to the receiver MSs 20 in one or more of the RLC segments transmitted with redundancy 225A or 225B. MSs 20 are optionally configured to identify these parameters. The positions in which these parameters are encoded are optionally excluded from participating s in the calculations of the FEC (these positions do not contain original data or FEC data). In some embodiments of the invention, the parameters are provided in segments 225A which anyhow do not carry application data. As described above, segments 225A are transmitted with redundancy and therefore their chances of being lost are small. Furthermore, in some cases, when segments 225A or 225B are lost the entire IP packet cannot be deciphered and therefore the parameters are not needed.

In some embodiments of the invention, the same original data is to be transmitted in a plurality of different cells. Optionally, in order to avoid an MS 20 moving between cells to receive the same FEC units twice, which in case of data loss may prevent reconstruction of the original data, different cells transmit different sequences representing the same original data. Optionally, for each block of the original data, mediator 53 generates a larger number of non-correlated FEC units than required for FEC block 586 of the original data block. The original data together with all the generated FEC units are referred to together as a master sequence. For each cell, mediator 53 optionally generates IP packets using the original data and a sub-group of the FEC units in the master sequence. In some embodiments of the invention, the FEC units of the cells are selected such that adjacent cells have as few as common FEC units as possible.

Alternatively to all the cells receiving all the original data, some of the cells may receive less than all the original data and instead receive a higher proportion of FEC units. Thus, the difference between the content transmitted in adjacent cells may be enlarged. It is noted that different cells may receive the same ratio of FEC units versus original data units or different ratios.

In some embodiments of the invention, instead of transmitting different FEC units in different cells or in addition, the cells are instructed to transmit the data they receive in synchronization. Optionally, a cell which is not able to transmit the data at a predetermined rate discards some of the extra FEC units and/or original units it receives from each block, in order to be synchronized with other cells.

The above exemplary embodiment involves a cellular network, which generally has high packet loss rates, e.g., about 10%. It is noted, however, that the present invention is not limited for use with any specific network type or for any loss rate, although its importance increases with the loss rate of the network.

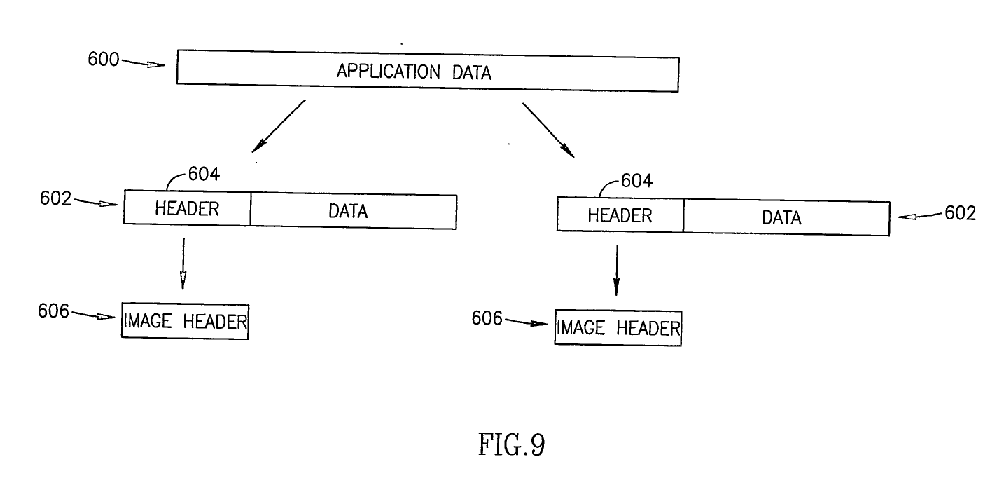

FIG. 9 is a schematic illustration of packets transmitted for a fragment of application layer data 600, in accordance with an exemplary embodiment of the invention. The application layer data 600 is optionally encapsulated in a single UDP packet which is fitted into one or more IP packets 602, as is known in the art. Each IP packet 602 has an IP header 604 which states the length of the IP packet. For each IP packet 602, an image packet 606 is optionally generated from the IP header of the packet. The image packet 606 optionally includes the IP header 604 of the original packet 602 and optionally one or more application headers. Image packet 606, however, does not include the entire data segment of the original packet, so as not to waste bandwidth. During transmission, each original packet is first transmitted and after a predetermined time the image packet 606 is transmitted.

The predetermined time between transmitting the original packet and transmitting the image packet 606 is optionally chosen to be relatively long such that the chances of image packet 606 being received before the original packet are as slight as possible, but not too long, so that if the original packet is lost, the image packet 606 is received before a time-out timer expires. Optionally, the predetermined time between transmitting the original packet and transmitting the image packet 606 is chosen based on measurements of the round trip delay of the connection.

If both the original packet and the image packet are received, the image packet being received later, the image packet will be discarded as being redundant. If only the image packet is received, the image packet may be used by the receiver to determine how much data was lost and/or the type of data lost.

In some embodiments of the invention, as described above, an image packet is generated for each packet to be transmitted. Alternatively, image packets 606 are generated only for some of the packets, for example for relatively long packets and/or for packets having a higher importance. Alternatively or additionally, image packets 606 are generated for a certain percent of randomly selected packets.

It will be appreciated that the above described methods may be varied in many ways, including, changing the order of steps, and the exact implementation used. The methods of the present invention may be performed in various protocol layers and may be performed for a single transmission system in a plurality of communication protocol layers. It should also be appreciated that the above described description of methods and apparatus are to be interpreted as including apparatus for carrying out the methods and methods of using the apparatus.

The present invention has been described using non-limiting detailed descriptions of embodiments thereof that are provided by way of example and are not intended to limit the scope of the invention. It should be understood that features and/or steps described with respect to one embodiment may be used with other embodiments and that not all embodiments of the invention have all of the features and/or steps shown in a particular figure or described with respect to one of the embodiments. Variations of embodiments described will occur to persons of the art.

It is noted that some of the above described embodiments may describe the best mode contemplated by the inventors and therefore may include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the elements and limitations as used in the claims. When used in the following claims, the terms “comprise”, “include”, “have” and their conjugates mean “including but not limited to”.

1. A method of transmitting data, comprising:
receiving data to be transmitted to a receiver;
determining information on the structure of the received data;
segmenting the received data into segments, in a manner determined responsive to the determined structure information; and
transmitting the segments to the receiver.

2. A method according to claim 1, wherein determining information on the structure of the received data comprises receiving the structure information from an upper communication layer providing the data.

3. A method according to claim 1, wherein determining information on the structure of the received data comprises determining the structure information from the received data.

4. A method according to claim 3, wherein determining the structure information from the received data comprises examining the received data for predetermined bit sequences.

5. A method according to claim 1, wherein determining information on the structure of the received data comprises identifying portions of the data which if not received by the receiver will have an adverse effect on utilizing at least one portion of the data received by the receiver.

6. A method according to claim 5, wherein identifying portions of the data comprises identifying packet headers of protocol layers above the segmenting layer.

7. A method according to claim 6, wherein identifying packet headers comprises receiving data from an upper communication layer.

8. A method according to claim 6, wherein identifying packet headers comprises scanning the data for sequences of headers.

9. A method according to claim 5, wherein segmenting the data into segments comprises segmenting in a manner which minimizes the number of segments including identified portions.

10. A method according to claim 9, wherein segmenting the data into segments comprises segmenting such that identified portions are included in a single transmitted segment.

11. A method according to claim 10, comprising padding with filler bits, one or more upper layer packets of the received data, if necessary, in order to ensure that identified portions are included in a minimal number of transmitted segments.

12. A method according to claim 5, wherein segmenting the data into segments comprises not positioning identified portions in the beginning of segments.

13. A method according to claim 5, wherein identifying portions of the data comprises identifying border portions of protocol layers above the segmenting layer, including a tail of a previous packet and a header of a following packet.

14. A method according to claim 13, wherein segmenting the data into segments comprises segmenting such that border portions are included in a single segment.

15. A method according to claim 13, wherein segmenting the data into segments comprises segmenting such that identified border portions appear at the beginning of segments.

16. A method according to claim 5, wherein segmenting the data into segments comprises segmenting such that at least some of the segments include at least one complete upper layer packet.

17. A method according to claim 16, wherein segmenting the data into segments comprises segmenting such that at least some of the segments includes a single upper layer packet.

18. A method according to claim 5, wherein segmenting the data into segments comprises including at least one specific identified portion in more than one segment.

19. A method according to claim 5, wherein transmitting the segments comprises transmitting at least some of the segments including identified portions in a manner which reduces the chances that their data will be lost, relative to at least some other segments.

20. A method according to claim 5, wherein transmitting the segments comprises transmitting segments including identified portions separated by at least a predetermined number of segments not including identified portions.

21. A method of transmitting data, comprising:
receiving data to be transmitted to a receiver;
segmenting the received data into segments;
identifying segments including received data which is important for reassembly; and
transmitting segments identified as including important data, with a reduced loss rate, relative to at least some of the non-identified segments.

22. A method according to claim 21, wherein identifying segments including received data which is important for reassembly comprises identifying portions of the data which if not received by the receiver will have an adverse effect on utilizing data in at least one segment received by the receiver.

23. A method according to claim 21, wherein identifying segments including received data which is important for reassembly comprises identifying headers of one or more upper layer protocols, above an identifying layer.

24. A method according to claim 21, wherein identifying segmentsi ncluding received data which is important for reassembly comprises identifying based on information from an upper layer communication layer providing the data.

25. A method according to claim 21, wherein identifying segmentsi ncluding received data which is important for reassembly comprises identifying based on an examination of the received data.

26. A method according to claim 21, wherein transmitting segments identified as including important data, with a reduced loss rate comprises transmitting segments including important data on a low error rate channel.

27. A method according to claim 21, wherein transmitting segments identified as including important data, with are duced loss rate comprises transmitting for segments including important data, at least one additional segment including the important data of the segment.

28. A method according to claim 27, wherein transmitting the at least one additional segment comprises transmitting an additional segment including substantially the same data as the original segment.

29. A method according to claim 27, wherein transmitting the at least one additional segment comprises transmitting an additional segment including substantially only the important data of the original segment.

30. A method according to claim 27, wherein transmitting the at least one additional segment comprises transmitting at least two segments including the important data of the original segment, each of the at least two segments including a portion of the data of the original segment not included by the others of the at least two segments.

31. A method according to claim 27, wherein transmitting the at least one additional segment comprises transmitting the at least one additional segment separated from the transmission of the original segment by at least a predetermined number of segments or at least a predetermined amount of time.

32. A method according to claim 27, wherein the receiver is not adapted to handle the transmitted at least one additional segment.

33. A method according to claim 21, wherein transmitting segments identified as including important data, with a reduced loss rate comprises transmitting segments including important data with a forward error correction code.

34-41. (canceled)

42. A method according to claim 21, wherein segmenting the received data into segments comprises segmenting in a manner adjusted responsive to information on a structure of the received data.

43. A method according to claim 42, wherein the information on the structure of the received data is received from an upper communication layer providing the data.

44. A method according to claim 42, wherein the information on the structure of the received data is determined from the received data.

45. A method according to claim 42, wherein receiving the data comprises receiving data protected by a forward error correction FEC code.

46. A method according to claim 45, wherein the received data is protected by an erasure FEC code.

47. A method according to claim 45, wherein the received data is protected by an FEC code, such that each FEC unit of the FEC code is in a separate segment resulting from the segmenting.

48. A method according to claim 42, wherein segmenting the received data into segments comprises segmenting into radio link control RLC frames.

49. A method according to claim 42, wherein the segmentation is performed in a manner which minimizes the number of segments important for reassembly.

50. A method of preparing data for transmission, comprising:
receiving, by an upper protocol layer, data to be transmitted to a receiver;
determining, by the upper layer, how data provided to a protocol layer lower than the upper layer is segmented in preparation for transmission to the receiver; and
generating, by the upper layer, an upper layer representation for the received data, responsive to the determination of how data will be segmented.

51. A method according to claim 50, comprising:
segmenting the protected data block into segments; and
transmitting the segments to the receiver.

52. A method according to claim 51, wherein segmenting the protected data into segments comprises segmenting in a plurality of protocol layers.

53. A method according to claim 51, wherein segmenting the protected data into segments comprises segmenting responsive to information received from the upper protocol layer.

54. A method according to claim 51, wherein segmenting the protected data block comprises segmenting into radio link control RLC frames.

55. A method according to claim 51, wherein segments received by the receiver with one or more data errors are discarded entirely and replaced by filler bits.

56. A method according to claim 55, comprising identifying the filler bits, by an upper layer of the receiver, and decoding the received data in accordance with a forward error correction FEC code, responsive to identifying the filler bits.

57. A method according to claim 50, wherein generating the upper layer representation comprises generating a protected data block in accordance with a forward error correction FEC code.

58. A method according to claim 57, wherein segmenting the received data into segments comprises segmenting into segments each having an amount of the received data from a limited number of possible amountsand wherein the generation of the FEC code is adapted to the possible amounts of data in the segments.

59. A method according to claim 57, wherein generating the FEC code comprises generating an erasure FEC code.

60. A method according to claim 57, wherein generating the FEC code comprises generating FEC units of a size selected responsive to a size of segments into which the data will be segmented.

61. A method according to claim 57, wherein generating the FEC code comprises generating FEC units of a same size as a size of a payload of segments into which the data will be segmented.

62. A method according to claim 57, wherein generating the FEC code comprises generating FEC units, such that each FEC unit is in a separate segment resulting from the segmentation.

63. A method according to claim 57, wherein generating the FEC code comprises generating FEC units, such that each segment will include data only from a single FEC unit.

64. A method according to claim 57, wherein generating the FEC code comprises generating FEC units, aligned to the segments.

65. A method according to claim 57, wherein generating the FEC code comprises dividing the data into FEC units, such that the FEC units of a single protected data block include at least two FEC units including different amounts of the received data.

66. A method according to claim 57, wherein generating the FEC code comprises dividing the data into FEC units, such that the FEC units include at most two different amounts of the received data.

67. A method according to claim 57, wherein generating the FEC code comprises adding padding bits to the received data responsive to the determination of how the data will be segmented and generating the FEC code for the data with the added padding bits.

68. A method according to claim 67, wherein the padding bits are not transmitted.

69. A method according to claim 68, wherein adding the padding bits comprises adding padding bits such that the added padding bits complement the payloads of the segments, so that the substantially all the segments together with the padded bits are the same size.

70. A method according to claim 50, wherein the generating of the upper layer representation and the segmenting are performed by two different physical entities.

71. A method according to claim 50, wherein the generating of the upper layer representation and the segmenting are performed by two protocol layers separated from each other by at least one intermediate protocol layer.

72. A method according to claim 50, wherein the generating of the upper layer representation and the segmenting are performed by two different protocol layers which generally avoid interrelation.

73. A method according to claim 50, wherein generating the upper layer representation comprises adding padding bits to the received data, responsive to the determination of how the data will be segmented.

74. A method according to claim 73, wherein adding the padding bits comprises adding padding bits which are transmitted with the received data.

75. A method according to claim 73, wherein the received data is in the form of IP packets and wherein adding the padding bits comprises adding padding bits such that each IP packet begins att he beginning of a segment.

76. A method according to claim 50, comprising adding padding bits to the upper layer representation of the received data, by a protocol layer lower than the upper protocol layer, in order to achieve alignment of the upper layer representation to the segments.

77. Apparatus for preparing data for transmission, comprising:
an inputi nterface adapted to receive data for transmission;
an output interface adapted to forward data to a lower layer protocol; and
a processor configured to determine how data provided through the output interface will be segmented in preparation for transmission and to generate an upper layer representation for data received through the input interface, responsive to the determination of how the data will be segmented.

78. Apparatus according to claim 77, wherein the processor is configured to transfer the protected data block through the output interface, not segmented in accordance with the determination.

79. A method according to claim 1, wherein receiving the data comprises receiving data protected by a forward error correction FEC code.

80. A method according to claim 1, wherein segmenting the received data into segments comprises segmenting into radio link control RLC frames.

81. A method according to claim 1, wherein the received data is protected by an erasure FEC code.

82. A method according to claim 1, wherein the received data is protected by a FEC code, which takes the segmenting method into account.

83. A method according to claim 1, wherein segmenting the received data into segments comprises segmenting into segments having a limited number of predetermined layouts of the received data.

84. A method according to claim 1, wherein segmenting the received data into segments comprises segmenting into segments having a limited number of predetermined amounts of the received data.

85. A method according to claim 1, wherein segmenting the received data into segments comprises segmenting into segments having only two different amounts of the received data.
